(19) United States
(12) Patent Application Publication
(10) Pub. No.: US 2025/0206047 A1
(43) Pub. Date: Jun. 26, 2025

(54) Media Processing Device with Variable Media Tensioning System and Associated Methods

(71) Applicant: ZEBRA TECHNOLOGIES CORPORATION, Lincolnshire, IL (US)

(72) Inventors: Morgan Hassan Malone, Swansea, MA (US); Raymond E. Maynard, Westerly, RI (US); Angel B. Rosales, Port Hueneme, CA (US); Cesar Michel, Oxnard (CA); Kurt Botsai, Thousand Oaks, CA (US)

(21) Appl. No.: 18/390,327

(22) Filed: Dec. 20, 2023

(51) Int. Cl. B65H 23/182; B65H 16/10

(52) U.S. Cl. CPC B41J 15/16; B41J 11/04; B41J 15/005; B41J 15/02; B65H 16/10; B65H 23/1825; B65H 2511/20; B65H 2801/12

(57) ABSTRACT

A media processing device includes a platen roller opposing spaced from a printhead to form a nip. The platen roller rotates at a platen speed to pull media from a media roll in a downstream direction along a media path. A media supply spindle configured to support the media roll and to rotate at a payout speed to dispense media from the media roll. A dancer arm includes a roller configured to engage the media along the media path and a sensor detect a position of the dancer arm. A logic circuit receives an output signal from the sensor, determines that the position of the dancer arm has changed based on the signal, and adjusts the payout speed of the media supply spindle.

### BACKGROUND

Tensioning of media in a media processing device can be important to ensure proper operation of the media processing device. When the media supply is in the form of a continuous web of media on a media roll, an opposing force required to maintain tension on the web of media can change as the media is consumed by the media processing device.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates an example media processing device in accordance with embodiments of the present disclosure.

FIG. 2 illustrates a side profile of an internal cavity of the example media processing device of FIG. 1 in accordance with embodiments of the present disclosure.

FIG. 3 illustrates another example media processing device in accordance with embodiments of the present disclosure.

FIG. 4 is a block diagram illustrating example components of a media processing device for maintaining tension of media in accordance with embodiments of the present disclosure.

FIGS. 5-6 illustrate an embodiment of a dancer arm for maintaining tension on media in accordance with embodiments of the present disclosure.

FIG. 7 is a flowchart illustrating an example process for controlling tension of media in a media processing device in accordance with embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The components of embodiments of the present disclosure have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Embodiments of media processing devices of the present disclosure can process (e.g., print, encode, etc.) media by drawing the media from the media source and routing the media proximate to various media processing components (e.g., printhead(s), RFID reader/encoder, magnetic stripe reader/encoder, etc.). Processing the media from the media source may facilitate a continuous or batch printing and/or encoding process. As an example, embodiments of media processing devices of the present disclosure may be configured to print and/or encode media drawn from a media source, such as a roll of media. The media may include a continuous web such as a spool of lined or linerless media. As a non-limiting example, the continuous web of media can be coated on one surface with a pressure sensitive adhesive and can include a printable surface on the opposite surface. For lined media, the media can include a release liner overlaying the adhesive that can be removed to expose the adhesive when the media is output from the media processing devices and/or when the media will be affixed to an object. For linerless media, the media is devoid of the release liner. For thermal transfer printing, the printable surface of the linerless media is configured to receive a pigment (e.g., ink, resin, wax-resin, etc.) that is transferred from a ribbon supply. For direct thermal printing, a thermal printhead of the printer directly contacts the printable surface triggering a chemical and/or physical change in a thermally sensitive dye covering and/or embedded in at least a portion of the printable surface of the media. The media also can include a radiofrequency identification device (RFID) inlay that can be written to and/or read by a RFID encoder.

The web of media is routed along a media path from the media supply to a print and/or encoding position located adjacent to the printhead (e.g., a thermal printhead) and/or the RFID encoder. The position of components of the media processing device relative to other components can be defined based on the flow of media along the media path from the media source to the outlet and/or a take-up roll. For example, the media source is upstream of the printhead, the printhead is downstream of the media source (the web of media), and the outlet of the media processing device is downstream of the media source and the printhead along the media path. The continuous web of media is pulled through the media path by a driven platen roller. The printhead is generally configured to form a nip with the platen roller to pinch the media between the printhead and the platen roller. In addition to pulling the media, or in the alternative, this pinching or compressive force aids in achieving adequate print quality. Once printed and/or encoded, the printed and/or encoded portion of the media can be advanced outwardly from the printer through a media outlet by the platen roller where it can be cut and/or torn to separate the printed and/or encoded media from the media supply, can be wound on a media take-up roll for subsequent use. For media that includes a liner, the media processing device can also include a peeler downstream of the nip formed by the printhead and the platen roller. The peeler can separate the liner from the media such that the media is output from the media processing device with the adhesive of the media exposed, while the liner can be wound on the media take-up roll.

The platen roller and the nip formed by the paten roller and the printhead can aid in maintaining tension of the continuous web of media along the media path. However, slack can form in the web of media along the media path without providing a counter force to the force applied to the media by the platen roller to pull media through the media path and over tensioning or the media can occur is the counter force is excessive. While some systems rely on media roll itself to provide the counter force to resist the force applied by the platen to maintain adequate tension on the web of media, some systems can provide mechanisms for providing a counter force. As the media is consumed by the media processing device, the size, weight, and/or resistance or counterforce applied by the media roll itself decreases. Thus, while adequate tension may be applied to the web of media when the media source is first loaded into the media processing device, over time as the media is consumed, the counterforce required to maintain adequate tension on the media along the media path changes. Embodiments of the present disclosure advantageously provide a tensioning mechanism that is configured to apply a variable counterforce to the media as the media is consumed by the media processing device to maintain a target tension on the web of media along the media path. By applying this variable counterforce, embodiments of the tensioning mechanism can mitigate instance of slack in the web of media or conversely can mitigate over tensioning of the media along the media path throughout the consumption of the media by the media processing device; thereby ensuring proper operation of the media processing device and correct processing of the media.

In accordance with embodiments of the present disclosure, a media processing device is disclosed. The media processing device includes a printhead, a platen roller, a media supply spindle, a dancer arm, a sensor, and a logic circuit. The platen roller is opposingly spaced from the printhead to form a nip and is configured to rotate at a platen speed to feed media of a media roll along a media path. The media supply spindle is configured to support the media roll and is configured to rotate at a payout speed. The dancer arm has a roller configured to engage the media along the media path between the media roll and the platen roller. The sensor is configured to detect a position of the dancer arm and output a signal corresponding to the position of the dancer arm. The logic circuit configured to receive the signal, determine that the position of the dancer arm has changed based on the signal, and adjust the payout speed of the media supply spindle. The platen roller can rotate at the platen speed to pull media from the media roll in a downstream direction along the media path and the media supply spindle can rotate at the payout speed to dispense the media from the media roll in the downstream direction along the media path.

In accordance with embodiments of the present disclosure, a media processing device is disclosed that includes a non-transitory computer-readable memory and a logic circuit. The non-transitory computer readable memory stores instructions and the logic circuit is configured to execute the instructions to drive a platen roller via a motor to a platen speed; drive a media supply spindle via the motor or a different motor to a payout speed; determine whether to adjust a tension of the media along a supply path between the media supply spindle and the platen roller in response to a position of a dancer arm; and adjust the payout speed of the media supply spindle to adjust the tension based on the position of the dancer arm. The media processing device can include the sensor configured to detect a position of the dancer arm and output the signal to the logic circuit that is indicative of the position of the dancer arm.

In accordance with embodiments of the present disclosure, a method is disclosed. The method includes driving a platen roller, via a motor, to a platen speed; driving a media supply spindle, via the motor or a different motor, to a payout speed; determining whether to adjust a tension of the media along a supply path between the media supply spindle and the platen roller in response to an output of a sensor configured to detect a position of a dancer arm operatively engaging the media; and adjusting the payout speed of the media supply spindle to adjust the tension of the media based on the output of the sensor.

In accordance with embodiments of the present disclosure, a distal end of the dancer arm includes the roller and a proximal end of the dancer arm is moveably mounted such that the dancer arm moves in response to a change in tension on the media. The proximal end of the dancer arm can be rotatably mounted such that the dancer arm rotates about an axis of rotation. The media supply spindle rotates about the axis of rotation such that the media supply spindle and the dancer arm are disposed coaxially relative to the axis of rotation and/or the dancer arm rotates independently relative to the media supply spindle.

In accordance with embodiments of the present disclosure, the media processing device includes a motor and a drive train. The motor is operatively coupled to the media supply spindle via the drive train and the logic circuit is configured to control a motor speed and a motor torque based on information about consumption of the media from the media roll.

In accordance with embodiments of the present disclosure, the media processing device can include a media take-up spindle, a further dancer arm, and/or a further sensor. The media take-up spindle can be configured to rotate at a take-up speed to wind media or a liner of the media about the media take-up spindle. The further dancer arm has a further roller configured to engage the media along the media path between the platen roller and the media take-up spindle. The further sensor can be configured to detect a position of the further dancer arm and output a further signal corresponding to the position of the further dancer arm. The logic circuit can be configured to receive the further signal, determine that the position of the further dancer arm has changed based on the further signal, and adjust the take-up speed of the media take-up spindle.

In accordance with embodiments of the present disclosure, in response to the logic circuit adjusting the payout speed of the media supply spindle, a tension of the media along the media path is increased or decreased and the position of the dancer arm moves to a specified position that indicates the tension on the media satisfies a target tension for the media.

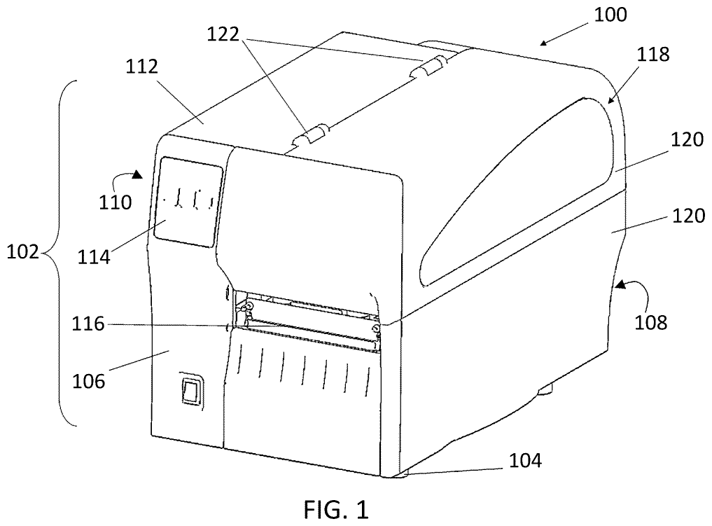

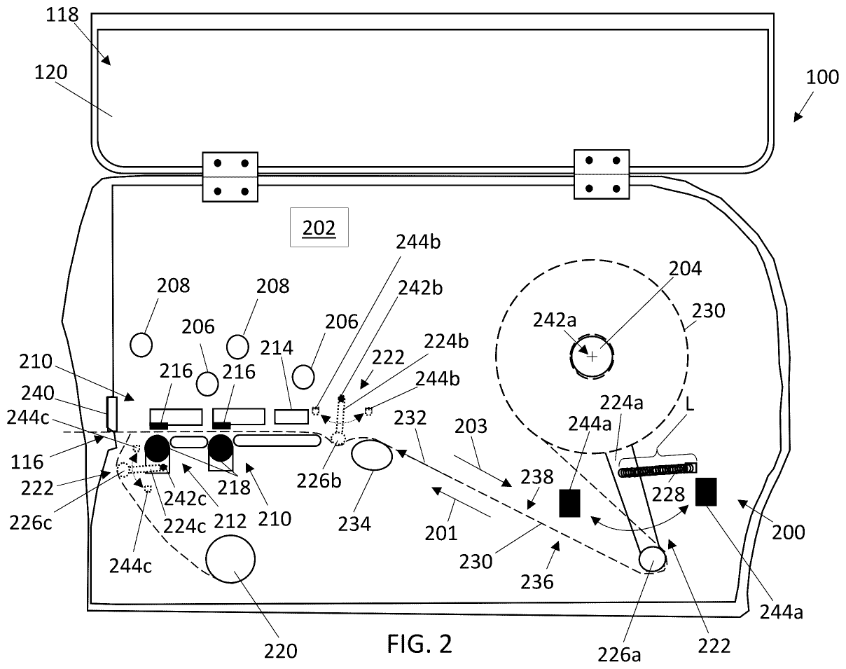

FIGS. 1-2 illustrate an example of a media processing device 100 in accordance with embodiments of the present disclosure. The media processing device 100 can be embodied as a printer (e.g., a direct thermal printer and/or a thermal transfer printer), RFID encoder, and/or other media processing devices. The media processing device 100 includes a housing 102 and a base 104. The housing 102 may include a front panel 106, a rear panel 108, a side panel 110, a support surface 112, and an access door assembly 118. The housing 102 may include a user interface 114 and a media outlet or exit 116. The media exit 116 may be arranged in the front panel 106 of the media processing device 100 and may be configured to expel media through a slot after it has been processed. The access door assembly 118 includes one or more doors 120 and can be hingedly attached to the support surface 112 with hinges 122. The access door assembly 118 is illustrated in the closed or operational position in FIG. 1, in which access to the internal components of the media processing device 100 may be precluded. In addition to keeping dirt, dust, and foreign objects from entering an internal cavity of the media processing device 100 and potentially contaminating the consumables or the electronics of the processing device 100, the closed position of the access door assembly 118 may also reduce noise and prevent users from inadvertently touching sensitive components.

The access door assembly 118 may pivot about hinges 122 through a range of approximately 180 degrees to a major support position to provide access to an interior cavity 200 of the media processing device 100 in an open or non-operational position as illustrated in FIG. 2. The hinges 122 may be located proximate a centerline of the housing 102 defined between the support surface 112 and the access door assembly 118. Positioning the hinges 122 proximate a centerline of the housing 102 allows the access door assembly 118 to pivot about hinges 122 and achieve the support position when the access door assembly 118 comes to rest on the support surface 112. In some embodiments, the access door assembly 118 may include at least a portion of the front panel 106 and/or a portion of the rear panel 108 to provide greater access to the interior cavity 200 when the access door assembly 118 is positioned in the open position. Operation of the media processing device 100 may be precluded when the access door assembly 118 is in the open position.

As shown in FIG. 2, when the access door assembly 118 is in the open position, components for loading and unloading consumables (e.g., media and/or ribbon) within internal cavity 200 can be accessible and components associated with processing media 230 along a media path 232 can be viewed. A downstream or forward direction of the media path 232 is denoted by the arrow 201 and an upstream or reverse direction of the media path 232 is denoted by arrow 203. Access to the internal cavity 200 can be provided, for example, at least partially, through at least three sides (e.g., the front side via a portion of the front panel 106, the access door side and top side through the access door assembly 118, and/or the rear side 108) which permit easier access and view of the components within the cavity 200.

A chassis 202 that supports at least some of the components for processing media 230 along the media path 232. The chassis 202 is a structural member configured to support at least some of the internal components in the internal cavity 200. The electronics, motors, and drive components (e.g., drive trains) of the media processing device 100 can be in a cavity on the other side of chassis 202 that can be generally inaccessible to the user without taking the media processing device 100 apart. The electronics, motors, and drive components can control an operation of at least some of the internal components within the internal cavity 200.

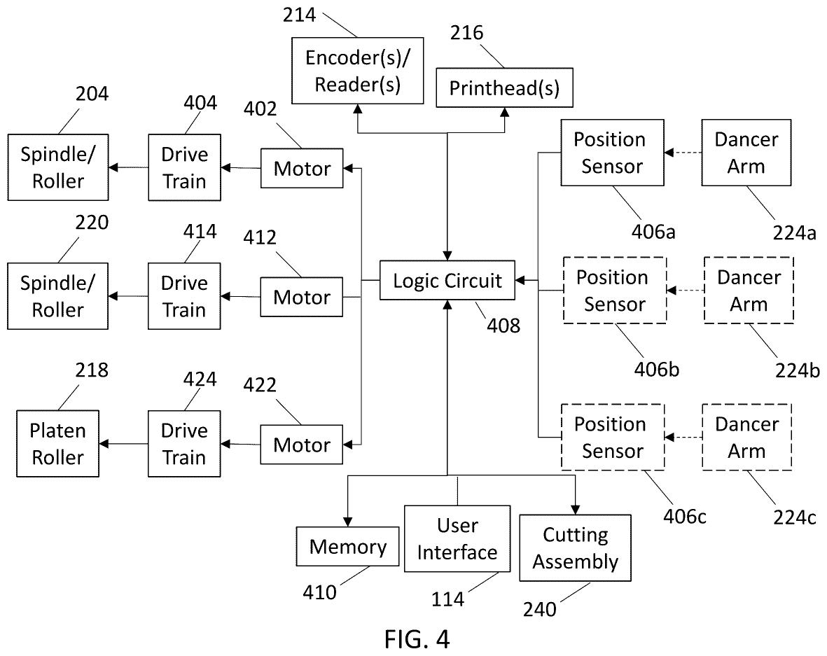

Referring to FIGS. 2 and 4, the internal components within the internal cavity 200 can include a media payout roller or a media supply spindle 204 that can hold or support a media spool or media roll (e.g., media 230), one or more ribbon supply spindles 206, one or more ribbon take-up spindles 208, one or more printhead assemblies 210, one or more platen assemblies 212, a RFID encoder 214, a media take-up roller or spindle 220, and one or more dancer arms 224a-c including rollers 226a-c configured to engage the media 230 at one or more positions along the media path 232. In one example, the media processing device 100 includes the dancer arm 224a and roller 224a and is devoid of the dancer arm 224b and the roller 226b and/or is devoid of the dancer arm 224c and the roller 226c. In one example, the media processing device is devoid of the dancer arm 224a and roller 226a and includes the dancer arm 224b and the roller 226b and/or includes the dancer arm 224c and the roller 226c. In one example, the media processing device 100 includes the dancer arm 224c and the roller 226c and includes the dancer arm 224a and the roller 224a or includes the dancer arm 224b and the roller 224b. The media take-up spindle 220 can be configured to hold the media 230 or the liner of the media 230 after the media 230 is processed. The one or more ribbon supply spindles 206 can hold spools of an unused portion of ribbons while the ribbon take-up spindle 208 can hold spools of used portions of the ribbons. While an embodiment of the media processing device 100 has been illustrated to include ribbon supply and take-up spindles 206 and 208, respectively, embodiments of the media processing device 100 may not include ribbon supply and take-up spindles 206 and 208, e.g., for embodiments of the media processing device that do not require a ribbon to print on media 230 (e.g., embodiments implemented via direct thermal printing).

The one or more printhead assemblies 210 can include printheads 216 (e.g., a thermal printhead). The one or more platen assemblies 212 can include platen rollers 218. The one or more printhead assemblies 210 can move between a disengaged position, in which the printheads 216 are positioned away from their respective platen assemblies 212 such that the printheads 216 are not positioned to print on media 230, and an engaged position, in which the printheads 216 are adjacent to and forms a nip with their respective platen rollers 218 and the printheads 216 are positioned to print on media. After the one or more printheads 216 print on the media 230 (e.g., via the ribbon or direct thermal) and/or the RFID encodes an RFID inlay on the media 230, the media 230 can be dispensed from the media processing device 100 via the media exit 116 and cut by a cutting assembly 240 or can be wound about the media take-up spindle 220. In some example individual media elements can be held on a continuous web of media via the liner such that a cutter is not required at the media exit 116.

The chassis 202 supports the media supply spindle 204, the one or more ribbon supply spindles 206, the one or more ribbon take-up spindles 208, the one or more printhead assemblies 210, the one or more platen assemblies 212, the RFID encoder 214, the media take-up spindle 220, the dancer arms 224a, 224b, and/or 224c, and/or the cutting assembly 240, as well as the electronics and drive components (e.g., motors 402, 412, and/or 422; drive trains 404, 414, and/or 424 shown in FIG. 4) behind the chassis 202 operatively coupled to the media supply spindle 204, the one or more ribbon supply spindles 206, the one or more ribbon take-up spindles 208, the RFID encoder 214, the printheads 216, the platen rollers 218, and/or the media take-up spindle 220 to control (e.g., via a logic circuit 408 shown in FIG. 4) the media supply spindle 204, the one or more ribbon supply spindles 206, the one or more ribbon take-up spindles 208, the RFID encoder 214, the printheads 216, and/or the platen rollers 218 (e.g., to rotate the media supply spindle 204, the ribbon supply spindles 206, the ribbon take-up spindles 208, the platen rollers 218, the media take-up spindle 220, the one or more variable media tensioning apparatuses 222, and/or the cutter 240; and/or to energize the RFID encoder 214 and/or the printheads 216).

In an example operation with reference to FIGS. 1-2 and 4, before a printing and/or encoding operation may begin, the media 230 is loaded into the media processing device 100. The supply of media 230 (e.g., a media roll) can be supported by the spindle 204 and routed along the media path 232 from the media supply and past the printhead 216 and platen roller 218. A core of the media roll can be secured on the spindle 204 such that the media generally does not freely rotate relative to the spindle. Rather, the core is “locked” to the spindle 204 such that the spindle 204 and the core of the media roll rotate in unison. One or more media guides 234 can support and guide the media 230 along the media path 232. The continuous web of media 230 can be coated on one surface 236 with a pressure sensitive adhesive and can include a printable surface on the opposite side 238. For thermal transfer printing, the printable surface of the media is configured to receive a pigment (e.g., resin, wax-resin, etc.) that is transferred from an ink ribbon installed on the ribbon supply and take-up spindles 206 and 208, respectively. For direct thermal printing, a thermal printhead of the media processing device 100 directly contacts the printable surface triggering a chemical or physical change in a thermally sensitive dye covering at least a portion of the printable surface of the media.

After the media 230 is loaded into the internal cavity 200 and fed through the media path 232 past a print mechanism formed by the printheads 216 and the platen rollers 218, the printhead assemblies 210 can be positioned such that the printheads 216 and the platen roller 218 form a nip. The platen rollers 218 can be driven by a platen drive motor 422, e.g., via a platen drive train 424, to rotate about an axis of rotation of the platen roller 218 (platen axis of rotation) at a specified platen or a platen speed to feed the media 230 along the media path 232. For example, the platen roller can rotate in a first direction to feed the media 230 along the media path 232 in a downstream direction or can rotate in a second direction to feed media along the media path 232 in an upstream direction. When the platen roller 218 initially starts to rotate, the speed at which the platen roller 218 rotates can gradual increase until it reaches the specified speed. In one example, to maintain tension on the media 230 during a printing and/or encoding operation, as the media 230 is pulled by the platen roller 218 along the media path 232 in the downstream direction, a media payout motor 402 can drive, e.g., via a media payout drive train 404, the spindle 204 to rotate about an axis of rotation (a payout spindle axis of rotation) at a specified payout speed and/or with a specified torque to dispense the media 230 in the downstream direction while maintaining tension on the media 230 along the media path 232 between the media supply and the nip formed between the printhead 216 and the platen roller 218. In one example, to maintain tension on the media 230 during a rewinding operation, as the media 230 is fed by the platen roller 218 along the media path 232 in the upstream direction, the media payout motor 402 can drive, e.g., via the media payout drive train 404, the spindle 204 to rotate about an axis of rotation (a payout spindle axis of rotation) at a specified payout speed and/or with a specified torque to dispense the media 230 in the upstream direction while maintaining tension on the media 230 along the media path 232 between the media supply and the nip formed between the printhead 216 and the platen roller 218. For embodiments and/or applications that utilize the media take-up spindle 220, to maintain tension on the media 230 as the platen 218 outputs the media downstream along the media path 232, a media take-up motor 412 can drive, e.g., via a media take-up drive train 414, the spindle 220 to rotate about an axis of rotation (a take-up spindle axis of rotation) at a specified take-up speed and/or with a specified torque to maintain tension on the media 230 along the media path 232 between the nip formed between the printhead 216 and the platen roller 218 and the media take-up spindle 220. The drive trains 404, 414, and/or 424 can include one or more drive components configured to transfer or inhibit the transfer of movement from the motors 402, 412, and/or 422. As an example, the drive trains 404, 414, and/or 424 can include drive shafts, gears, belts, clutches, actuators, brakes, and the like. In some embodiments, a single one of the motors 402, 412, and/or 422 can be selectively and/or operatively coupled to multiple ones of the drive trains 404, 414, and/or 424 to drive rotation of the spindle 204, the platen roller 218, and/or the media take-up spindle 220.

In one example, the media 230 can be biased by the media payout motor 402 to oppose the driving force produced by the rotation of the platen roller 218 (e.g., based on the speed of the motor 402 being used to dispense the media 230) to maintain tension in the web of media 230 as it is pulled along the media path 232 through the media processing device 100 by the platen roller 218 and the media 230 can be biased by the driving force of the media take-up motor 412 on the spindle 220 (e.g., based on the speed of the motor 412 being used to wind the media 230 or a liner associated with the media 230) to maintain tension in the web of media 230 as it is pulled along the media path 232 through the media processing device 100 by the platen roller 218. In one example, the speed at which the platen roller 218 rotates is a specified static or fixed parameter during operation of the media processing device 100, while the speed at which and/or the torque with which the spindles 204 and 220 rotate can vary in accordance with embodiments of the present disclosure. Once printed and/or encoded, the printed portion of the media 230 is advanced outwardly from the media processing device 100 through a media exit 116 by the platen roller assembly 218 where it can be cut and/or torn to separate the printed and/or encoded media from the media supply e.g., the cutting assembly 240 can be disposed proximate to the media outlet 116 (e.g., between the printing mechanism and the media outlet) to cut the media as it exits the media outlet 116. Alternatively, the printed and/or encoded media (or the liner of the media) can be wound about the media take-up spindle 220.

As shown in FIG. 2, one or more of the dancer arms 224a-c and corresponding rollers 226a-c can be disposed at different positions along the media path 232 to place tension on the media 230 as it moves along the media path 232. As one example, the dancer arm 224a and associated roller 226a and/or the dancer arm 224b and the associated roller 226b can be positioned such that the roller 226a and/or 226b can engage the media 230 along the media path 232 downstream of the media source and upstream of the printhead assemblies 210 to maintain tension of the media 230 along the media path 232 between the media source and the printhead(s) 216. As another example, the dancer arm 224c and associated roller 226c can be positioned such that the roller 226c can engage the media 230 or the liner portion of the media 230 along the media path 232 downstream of the printhead assemblies 210 and upstream of the media take-up spindle 220 to maintain tension of the media 230 or the liner of the media along the media path 232 between the printhead(s) 216 and the media take-up spindle 220.

The dancer arms 224a-c can each be biased, for example, by a biasing member, such as a biasing member 228 (e.g., spring member, such coil spring, torsion spring, etc., an elastic member formed using a polymer, and/or other resilient member) and can pivot or rotate about an axis 242a-c of rotation such that the dancer arm 222 can travel between stops 244a-c. In an alternative embodiment, the dancer arms 224a-c can be configured to translate along a path instead of or in addition to rotating. Illustrative biasing member 228 is illustrated as a spring member relative to dancer arm 224a in FIG. 2 and dancer arms 224b-c can likewise be biased by corresponding biasing members 228. For embodiments that include the dancer arm 224a and roller 226a, a proximal end of the dancer arm 224a can be coaxial with the media supply spindle 204 about the axis of rotation 242a but can be independently rotatable relative to the media supply spindle 204 to allow the dancer arm 224a to travel between the stops 244a. For embodiments that include the dancer arm 224b and roller 226b, a proximal end of the dancer arm 222 can be supported about the axis of rotation 242b by the chassis 202 to allow the dancer arm 224b to travel between the stops 244b. For embodiments that include the dancer arm 224c and roller 226c, a proximal end of the dancer arm 222 can be supported about the axis of rotation 242b by, e.g., a portion of the one or more platen assemblies 212, to allow the dancer arm 224c to travel between the stops 244c. The biasing member for each dancer arm 224a-c can bias the dancer arms 224a-c towards one of the stops 244a-c, respectively, absent an opposing force from the media 230. That is, the media 230 can apply a force to the dancer arms 224a, 224b, and/or 224c as the media 230 is being moved along the media path 232 and the biasing member for each respective dancer arm 224a, 224b, and/or 224c can apply a counter force to the dancer arms 224a, 224b, and/or 224c to oppose the force applied by the media 230. When a difference between the force applied to the dancer arms 224a, 224b, and/or 224c by the media 230 and the counterforce applied to the dancer arms 224a, 224b, and/or 224c by the biasing members is constant, the dancer arms 224a, 224b, and/or 224c can remain at a given position along the travel between the stops 244a-c, respectively.

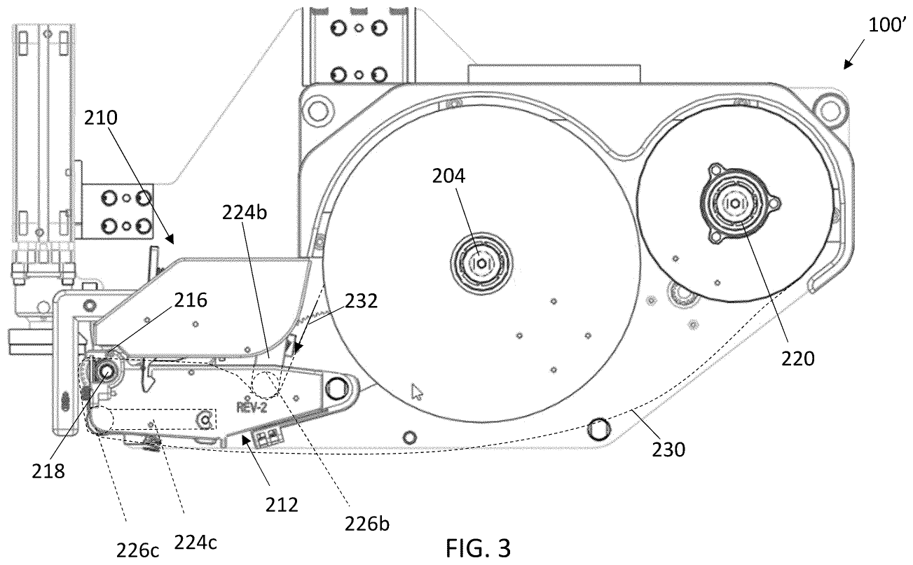

FIG. 3 illustrates an example media processing device 100′ which has a different arrangement of the media processing components. As shown in FIG. 3, the media processing device 100′ includes the media supply spindle 204 supporting the media 230, the printhead assembly 210 including the printhead 216, platen assembly 212 including the platen 218, the media take-up spindle 220, and the dancer arms 224b-c and the associated roller 225b-c. In the present example, the media processing device 100′ is devoid of the dancer arm 224a and the associated roller 226a. The dancer arm 224b and the roller 226b are disposed such that the roller 226b engages the media 230 downstream of the media supply and upstream of the printhead 216.

Referring to FIGS. 2 and 3, embodiments of the media processing devices 100 and 100′ can be configured to increase or decrease a speed at which and/or the torque with which the media supply spindle 204 and/or the media take-up spindle 220 rotate in response to a sensed position of the dancer arms 224a-c, which can be indicative of a tension on the media 230 along the media path 232. For example, if the tension on the media 230 is too high relative to a target tension, the position of the dancer arms 224a-c may move in a first direction (e.g., generally in the downstream direction) with a force that is greater than the opposing force of the spring member 228 and if the tension on the media 230 is too light relative to the target tension, the position of the dancer arms 224a-c may move in a second direction (e.g., generally in a upstream direction) due to the counter force of the biasing members 228 pulling the dancer arms 224a-c, which is greater than the force pulling the biasing members 228 in the opposite direction. The media processing devices 100 and 100′ can be configured to attempt to maintain the dancer arms 224a-c in a specified position (e.g., a midway point between the respective travel stops 244a-c) during an operation of the media processing devices 100 and 100′ to maintain the tension on the media along the media path 232 using real-time feedback from the position sensors.

Alternatively, and/or in addition, still referring to FIGS. 2 and 3, embodiments of the media processing devices 100 and 100′ can be configured to increase or decrease a torque with which the media supply spindle 204 and/or the media take-up spindle 220 rotate in response to the sensed position of the dancer arms 224a, 224b, and/or 224c and/or in response to information about the media 230 and the consumption of the media 230, which can be determined and/or known by the media processing device 100 and 100′. As an example, with respect to the latter, the information about the media 230 can include a media type, width, media roll diameter, a media thickness, a target tension, and/or other information and the information about the consumption of the media 230 can include a rate at which the media is being consumed, a measure of revolutions of the media roll, a diameter of the media roll remaining as the media is being consumed, and/or other information regarding the consumption of the media 230. Using the information about the media 230 and the consumption of the media 230, the media processing device can adjusted the torque as the media is consumed to maintain the target tension on the media 230 along the media path. In one example, the media information can be entered by a user via the user interface (e.g., shown in FIGS. 1 and 4). In one example, the media roll (e.g., on the media core) can include a, radiofrequency identifier (RFID)/near-field communication (NFC) tag that stores the information about the media and one of the readers 214 can be positioned in the media processing device 100 and 100′ to read the tag when the media is loaded onto the media supply spindle. In one example, the information about the consumption of media can be determined based on a speed at which the media supply spindle rotates, a number of rotations of the spindle (e.g., as a number of steps of the motor 402 for embodiments in which the motor 402 is a stepper motor or a number of revolutions as determined by a rotary encoder monitoring the rotation of the motor drove shaft or the rotation of the media supply spindle), a platen speed at which the platen roller is operating. As an example, the using the information as a starting state for the media, the media processing devices 100 and 100′ can be configured to determine the information about the consumption of the media 230 from the operation of the media processing device 100 and 100′.

FIG. 4 illustrates an example block diagram for the media processing devices 100 and/or 100′. As shown in FIG. 4, the media processing device 100 and/or 100′ can include position sensors 406a, 406b, and/or 406c that are configured to sense a position of the dancer arms 224a, 224b, and/or 224c, respectively, and output signals indicative of the position of the dancer arms 224a, 244b, and/or 224c to a logic circuit 408, such as a processor, controller, FPGA, ASIC, or other logic circuit. The positions of the dancer arms 224a, 224b, and/or 224c can be correlated to loads on the respective spring members 228 biasing the dancer arms 224a, 224b, and/or 224c, respectively, e.g., based on an extension lengths L of the biasing members 228 at given positions of the dancer arms 224a, 224b, and/or 224c along their respective travel paths and spring rates of their respective spring members 228. The logic circuit 408 can be configured and/or programmed to execute code stored in memory 410 to process the output of the position sensor 406 to maintain a specified tension on the media by maintaining a current speed of the motors 402 and/or 404, increasing a speed and/or torque of the motors 402 and/or 404, or decreasing a speed and/or torque of the motors 402 and/or 404 based on whether the position of the dancer arms 224a, 224b, and/or 224c has deviated from their respective specified positions (e.g., as the media is being consumed and the tension varies), which is indicative of change of the load on the respective biasing members 228 of the dancer arms 224a, 224b, and/or 224c. The motor 402 can drive the media supply spindle 204 via a drive train 404, the motor 412 can drive the media take-up spindle 220 via a drive train 414, and the motor 422 can drive the platen roller 218 via a drive train 424. In one example, the sensor 406a can measure an angular or linear position of the dancer arm 224a, the sensor 406b can measure an angular or linear position of the dancer arm 224b, and/or the sensor 406c can measure an angular or linear position of the dancer arm 224c. The position sensors 406a-c can be, for example, proximity sensors, rotary encoders, inductive or capacitive sensors, (reflective or transmissive) light sensors, and the like. In one example, the motors 402, 412, and/or 422 can be stepper motors. In an example operation, the logic circuit 408 can continuously adjust the speed and/or torque of the motors 402 and/or 412 to adjust for changes in tension as the media is consumed using the real-time feedback of the position of the dancer arms 224a, 224b, and/or 224c. The adjustments to the speed and/or torque of the motors 402 and/or 412 can occur in a manner that a change in position of the dancer arms 224a, 224b, and/or 224c is not perceivable during an operation of the media processing devices 100 or 100′. That is, because the position sensors 406a, 406b, and/or 406c can continuously provide the logic circuit 408 with outputs corresponding to position of the dancer arm 224a, 224b, and/or 224c, respectively, the logic circuit 408 can react to the output of the position sensors 406a, 406b, and/or 406c in real-time with minimal delay (e.g., microseconds, milliseconds, etc.) to adjust the speed and/or torque of the motors 402 and/or 412 when only a slight change in the position of the dancer arms 224a, 224b, and/or 224c are detected.

In one example operation, referring to FIGS. 2 and 4 and with reference to the dancer arm 224a and associated roller 226a, when the media 230 is held at a specified tension along the media path 232 between the media source and the printhead 216, the dancer arm 224a can have a specified position along a travel length of the dancer arm 224a between the stops 244a. The platen roller 218 can be driven by the motor 422, via the drive train 424, to rotate at a first specified speed to pull the media 230 along the media path 232 and the media supply spindle 204 can be driven by the motor 402, via drive train 404, to rotate at a second specified speed, which may be the same or different than the first specified speed. As the media 230 is consumed and the diameter of the media supply roll decreases, the tension on the media 230 along the media path 232 between the media supply and the printhead 216 can continue to change and if the speed at which and/or torque with which the spindle 204 rotates does not change, the dancer arm 224a would eventual move and abut one of the stops 244. However, the logic circuit 408 can receive the output from the position sensor 406a corresponding to the position of the dancer arm 224a, and in response to the output, can adjust the speed at which and/or torque with which the spindle 204 rotates to adjust a tension on the media along the media path 232 and maintain the specified position of the dancer arm 224a throughout the operation.

In another example operation, the logic circuit 408 can be configured and/or programmed to execute code stored in memory 410 to maintain a specified tension on the media by maintaining a current speed and/or torque of the motors 402 and/or 404, increasing a speed and/or torque of the motors 402 and/or 404, or decreasing a speed and/or torque of the motors 402 and/or 404 based on the information about the media and the information about the consumption of the media, which is indicative of a change in the tension of the media 230 along the media path 232 as the media is consumed. In an example operation, the logic circuit 408 can continuously adjust the speed and/or torque of the motors 402 and/or 412 to adjust for changes in tension of the media as the media is consumed using the information about the media and the information about the consumption of the media. The adjustments to the speed and/or torque of the motors 402 and/or 412 can occur in a manner that maintains the tension on the media with a specified range of the target tension. For example, as the media is consumed the torque of the motor 402 can be decreased since the diameter and weight of the media decreases as the media is consumed; thereby reducing a power consumption of the media processing devices 100 and 100′. In one example, the logic circuit 408 can use a combination of positions of the dancer arms 224a, 224b, and/or 224c, the information about the media, and/or the information about the consumption of the media to determine a speed and/or torque for the motor to maintain the target tension on the media. In another example, for embodiments that utilize the information about the media and the information about the consumption of media, the media processing devices 100 and/100′ can be devoid of the dancer arms 224a, 224b, and/or 224c or can utilize dancer arms 224a, 224b, and/or 224c without requiring a position of the dancer arms 224a, 224b, and/or 224c to be monitored by the position sensors 406a, 406b, and/or 406c.

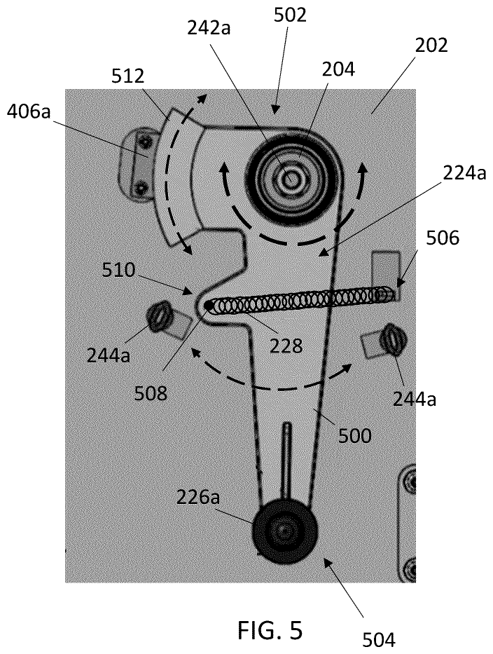

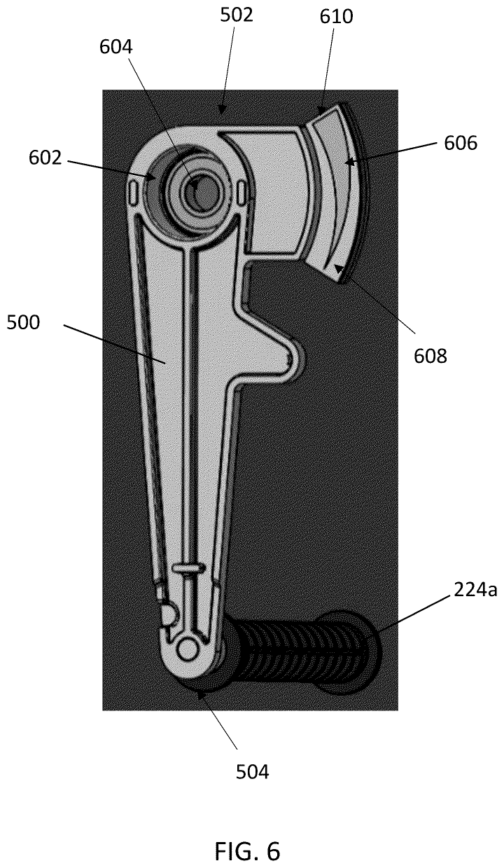

FIGS. 5 and 6 illustrate an example embodiment of the dancer arm 224a in accordance with embodiments of the present disclosure. While FIGS. 5 and 6 are illustrative of dancer arm 224a, example embodiments of the dancer arms 224b and 224c can be implemented in the same manner as the dancer arm 224a or can implemented differently than the dancer arm 224a. As shown in FIGS. 5 and 6, the dancer arm 224a can have a body 500 extending from a proximal end 502 and a distal end 504. The distal end 504 can include the roller 226 configured to contact media. The proximal end 502 can be mounted relative to the chassis 202 such that the body 500 of the dancer arm 224a can freely rotate about the axis of rotation 242a. For example, the proximal end can include a mounting recess 602 that can be supported by, e.g., a fixed shaft extending from the chassis and an opening 604 in the mounting recess 602 though which a rotatably driven shaft extends and is operative coupled to the media supply spindle 204 such that the body 500 of the dancer arm 224a and the spindle 204 are coaxial to each other about the axis of rotation 242a. The dancer arm 224a floats to the spindle 204 such that the dancer arm 224a and the spindle are separately rotatable about the rotation of axis 242a. One end of the spring member 228 can be operatively coupled to the chassis 202 via an anchor point 506 and the other end of the spring member 228 can be operatively coupled to an anchor point 508 on the body of the dancer arm 224a to bias the dancer arm 224a towards the right in the orientation illustrated in FIG. 5. The anchor point 508 can be disposed on a jog or projection 510 of the body 500 that extends in a direction that is generally perpendicular relative to a length of the body 500 measured between the proximal end 502 and the distal end 504.

The position sensor 406a can be operatively coupled to the chassis 202 proximate to the proximal end 502 of the body 500. A sensed portion 512 of the body 500 can be positioned to aligned with the position sensor 406a. For example, the sensed portion 512 can overlay the position sensor 406a. The body 500 including the sensed portion 512 can extend in a direction that is generally perpendicular relative to a length of the body 500 measured between the proximal end 502 and the distal end 504 and the sensed portion can have a curvature that extends circumferentially relative to the axis of rotation 242a. The sensor portion 512 can include a sensed area 606 that is disposed in proximity to the position sensor 406a when the body 500 of the dancer arm 224a is operatively coupled to the chassis 202. A surface area of the sensed area can have a wedge shape that is curved to generally match the curvature of the sensed portion 512 such that the surface area generally increases from a first end 608 of the sensed area to a second end 610 of the sensed area 606. The sensed area 606 can be a conductive material, e.g., metal. The position sensor 406a can be an inductive sensor where an inductance measured by the sensor 406 changes based on the which portion of the sensed area 606 is aligned with the position sensor 606. The change in inductance can be mapped to a position of the dancer arm 224a.

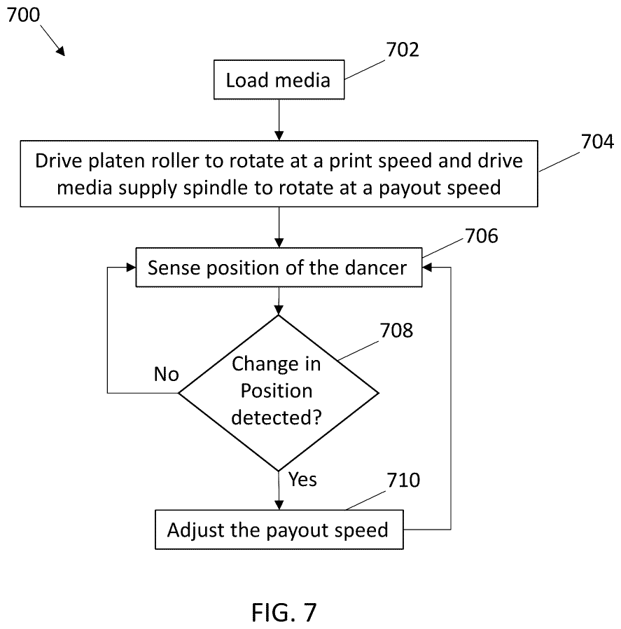

FIG. 7 is a flowchart illustrating an example process 700 for tensioning media in a media processing device (e.g., media processing device 100 and/or 100′) in accordance with embodiments of the present disclosure. At step 702, media (e.g., media 230) is loaded onto a media supply spindle (e.g., media supply spindle 204) of the media processing device and is routed through a media path (e.g., media path 232). In one example, the type of media loaded into the media processing device is known and a diameter of the roll and a desired tension can be specified for the media. A media payout speed can be specified for the media for the specified tension and a platen speed is specified for a platen roller (e.g., the platen roller 218). A position of a dancer arm (e.g., dancer arm 224a) is specified given the specified tension, a length of the dancer arm, an extension length of a spring member (e.g., spring member 228) biasing the dancer arm, and/or a spring rate of the spring member. At step 704, the platen roller is driven to the platen speed by a platen motor (e.g., motor 422 and associated drive train 424) and the media supply spindle is driven to the payout speed by a media supply motor (e.g., media supply motor 402 and associated drive train 404). At step 706, a position sensor (e.g., position sensor 406a) senses a position of the dancer arm as the media is being dispensed from the media roll and provides a sensor output to a logic circuit (e.g., logic circuit 408). At step 708, if there is no change in the position of the dancer arm, the logic circuit continues to monitor the output of the position sensor for a change in the position. In response to a detecting change in the position of the dancer arm, at step 710, the logic circuit can adjust the speed and/or torque of the media supply motor to increase or decrease the tension on the media along the media path so that the position of the dancer arm returns to the specified position. After step 710, the process 700 can return to step 706 to monitor the position of the dancer arm.

The above description refers to diagrams of the accompanying drawings. Alternative implementations of the example represented by the diagrams include one or more additional or alternative elements, processes and/or devices. Additionally or alternatively, one or more of the example elements of the diagram may be combined, divided, re-arranged or omitted.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A media processing device comprising:
a printhead;
a platen roller opposing spaced from the printhead to form a nip, the platen roller configured to rotate at a platen speed to feed media of a media roll along a media path;
a media supply spindle configured to support the media roll, the spindle configured to rotate at a payout speed;
a dancer arm having a roller configured to engage the media along the media path between the media roll and the platen roller;
a sensor configured to detect a position of the dancer arm and output a signal corresponding to the position of the dancer arm; and
a logic circuit configured to receive the signal, determine that the position of the dancer arm has changed based on the signal, and adjust the payout speed of the media supply spindle.

2. The media processing device of claim 1, wherein the platen roller rotates at the platen speed to pull media from the media roll in a downstream direction along the media path and the media supply spindle rotates at the payout speed to dispense the media from the media roll in the downstream direction along the media path.

3. The media processing device of claim 1, wherein a distal end of the dancer arm includes the roller and a proximal end of the dancer arm is moveably mounted such that the dancer arm moves in response to a change in tension on the media.

4. The media processing device of claim 3, wherein the proximal end of the dancer arm is rotatably mounted such that the dancer arm rotates about an axis of rotation.

5. The media processing device of claim 3, wherein the media supply spindle rotates about the axis of rotation such that the media supply spindle and the dancer arm of disposed coaxially relative to the axis of rotation.

6. The media processing device of claim 5, wherein the dancer arm rotates independently relative to the media supply spindle.

7. The media processing device of claim 1, further comprising:
a motor; and
a drive train,
wherein the motor is operatively coupled to the media supply spindle via the drive train and the logic circuit is configured to control a motor speed and a motor torque based on information about consumption of the media from the media roll.

8. The media processing device of claim 1, further comprising:
a media take-up spindle, the media take-up spindle configured to rotate at a take-up speed to wind the media or a liner of the media about the media take-up spindle; and
a further dancer arm having a further roller configured to engage the media along the media path between the platen roller and the media take-up spindle.

9. The media processing device of claim 7, further comprising:
a further sensor configured to detect a position of the further dancer arm and output a further signal corresponding to the position of the further dancer arm,
the logic circuit being configured to receive the further signal, determine that the position of the further dancer arm has changed based on the further signal, and adjust the take-up speed of the media take-up spindle.

10. The media processing device of claim 1, wherein, in response to the logic circuit adjusting the payout speed of the media supply spindle, a tension of the media along the media path is increased or decreased and the position of the dancer arm moves to a specified position that indicates the tension on the media satisfies a target tension for the media.

11. A method comprising:
driving a platen roller, via a motor, to a platen speed;
driving a media supply spindle, via the motor or a different motor, to a payout speed;
determining whether to adjust a tension of the media along a supply path between the media supply spindle and the platen roller in response to an output of a sensor configured to detect a position of a dancer arm operatively engaging the media; and
adjusting the payout speed of the media supply spindle to adjust the tension of the media based on the output of the sensor.

12. The method of claim 11, wherein a distal end of the dancer arm includes the roller that engages the media and a proximal end of the dancer arm is rotatably mounted such that the dancer arm rotates about an axis of rotation.

13. The method of claim 12, wherein driving the media supply spindle comprises driving the media supply spindle to rotate about the axis of rotation such that the media supply spindle and the dancer arm of disposed coaxially relative to the axis of rotation.

14. The method of claim 13, wherein the dancer arm rotates independently relative to the media supply spindle.

15. The method of claim 11, further comprising:
driving a media take-up spindle to a take-up speed to wind media or a liner of the about the media take-up spindle; and
engaging the media with a further roller of a further dancer arm along the media path between the platen roller and the media take-up spindle.

16. The method of claim 15, further comprising:
sensing a position of the further dancer arm; and
adjusting the take-up speed of the media take-up spindle based on the position of the further dancer arm.

17. The method of claim 16, wherein adjusting the take-up speed of the media take-up spindle, increases or decreases the tension of the media along the media path and the position of the further dancer arm moves to a specified position that indicates the tension on the media satisfies a target tension for the media.

18. The method of claim 11, wherein adjusting the payout speed of the media supply spindle, increases or decreases the tension of the media along the media path and the position of the dancer arm moves to a specified position that indicates the tension on the media satisfies a target tension for the media.

19. A media processing device comprising:
a non-transitory computer-readable memory storing instructions;
a logic circuit configured to execute the instructions to:
drive a platen roller via a motor to a platen speed;
drive a media supply spindle via the motor or a different motor to a payout speed;
determine whether to adjust a tension of the media along a supply path between the media supply spindle and the platen roller in response to a position of a dancer arm; and
adjust the payout speed of the media supply spindle to adjust the tension based on the position of the dancer arm.

20. The media processing device of claim 19, further comprising:
a sensor configured to detect a position of the dancer arm and output a signal to the logic circuit that is indicative of the position of the dancer arm.

21. The media processing device of claim 19, wherein, in response to the logic circuit adjusting the payout speed of the media supply spindle, the tension of the media along the media path is increased or decreased and the position of the dancer arm moves to a specified position that indicates the tension on the media satisfies a target tension for the media.
